(19) United States
(12) Patent Application Publication
(10) Pub. No.: US 2007/0239994 A1
(43) Pub. Date: Oct. 11, 2007

(54) Bio-metric encryption key generator

(76) Inventors: Vinod K. Kulkarni, Grayslake, IL (US); Michael T. Delahunty, Arlington Heights, IL (US)

Correspondence Address: MOTOROLA INC, 600 NORTH US HIGHWAY 45, ROOM AS437, LIBERTYVILLE, IL, 60048-5343, US

(21) Appl. No.: 11/398,845

(22) Filed: Apr. 5, 2006

(51) Int. Cl. H04L 9/00; H04K 1/00; G06F 12/14; H04L 9/32; G06F 11/30

(52) U.S. Cl. 713/189; 713/186; 380/44

(57) ABSTRACT

In a method of facilitating an encrypted communication for use in communication between a local device, operated by a user, and a remote device, a data representation of a biometric feature of the user is received from a biometric input interface. The data representation is transformed into a biometric encryption key using a predetermined set of rules. A device for communicating on a network includes a biometric input interface a processor, and a transceiver. The processor transforms a biometric data input from the biometric input interface into an encryption key and encrypts data for transmission onto the network using the encryption key, thereby generating encrypted data. The transceiver transmits the encrypted data to the network.

### BACKGROUND OF THE INVENTION

1. Field of the Invention

The present invention relates to communication systems and, more specifically, to a communication system that employs encryption of communicated data.

2. Background of the Invention

Many types of communications are vulnerable to interception. For example, some mobile telephone communications can be intercepted simply by using a certain type of radio scanner. In the recent past, this has caused considerable embarrassment to public figures who have engaged in what they thought were private communications, only to find transcripts of those communications published in supermarket tabloids. Such interception can also harm businesses as businesspeople communicate confidential information over their mobile devices.

To prevent such interception, many mobile devices can establish a secure tunnel, such as a virtual personal network (VPN) tunnel, with a secure gateway (SGW) in a number of ways, including use of a public key infrastructure and use of pre-shared keys in a symmetric keying technique that requires the mobile device and the network infrastructure (typically the SGW) to have knowledge about the keys for authentication and authorization. In mobile devices, pre-shared keys are typically included in the subscriber identity module (SIM) card provided by the service provider or are generated from a combination of information in the SIM card and information stored in the mobile handset.

Such a technique may not be sufficiently secure. Also, this technique is not scalable and the keys may be compromised, rendering the tunnel and network open to hackers. Furthermore, if a key is lost, then either the user is incapable of establishing a communication, or the communication will not be secure.

Some types of computer-based systems employ biometric input (e.g., input from a fingerprint scanner or a retinal scanner) to enable use of the system. Typically, this type of system requires the user to enter the biometric information (e.g., by passing a finger over a fingerprint scanner) as a condition for using the system. The biometric data is compared to the known biometric data for the user and it essentially replaces use of a password. However, such biometric data is not used to encrypt data being communicated.

Therefore, there is a need for an automated pre-shared keying technique that is scalable and secure.

There is also a need for a system that generates an encryption key that is specific to a user.

### SUMMARY OF THE INVENTION

The disadvantages of the prior art are overcome by the present invention which, in one aspect, is a method of facilitating an encrypted communication for use in communication between a local device, operated by a user, and a remote device. A data representation of a biometric feature of the user is received from a biometric input interface. The data representation is transformed into a biometric encryption key using a predetermined set of rules.

In another aspect, the invention is a method of provisioning an encrypted communication account for facilitating communications between a local device and a communications server, in which a single use only key is received from the local device at the communications server. An encrypted communication tunnel is established between the communications server and the local device employing the single use key. A biometric key is received from the local device via the encrypted communications tunnel. The biometric key is stored at the communications server in a memory associated with the local device.

In yet another aspect, the invention is a device for communicating on a network that includes a biometric input interface a processor, and a transceiver. The processor is configured to transform a biometric data input from the biometric input interface into an encryption key and to encrypt data for transmission onto the network using the encryption key, thereby generating encrypted data. The transceiver is configured to transmit the encrypted data to the network.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a top plan view of a wireless communications device employing one illustrative embodiment of the invention.

FIG. 2 is an elevational view of the embodiment shown in FIG. 1.

FIG. 3 is a schematic diagram of one embodiment of the invention.

FIG. 4 is a flowchart that represents a method employed in one embodiment of the invention.

FIG. 5 is a flowchart that represents a method employed in provisioning an account.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

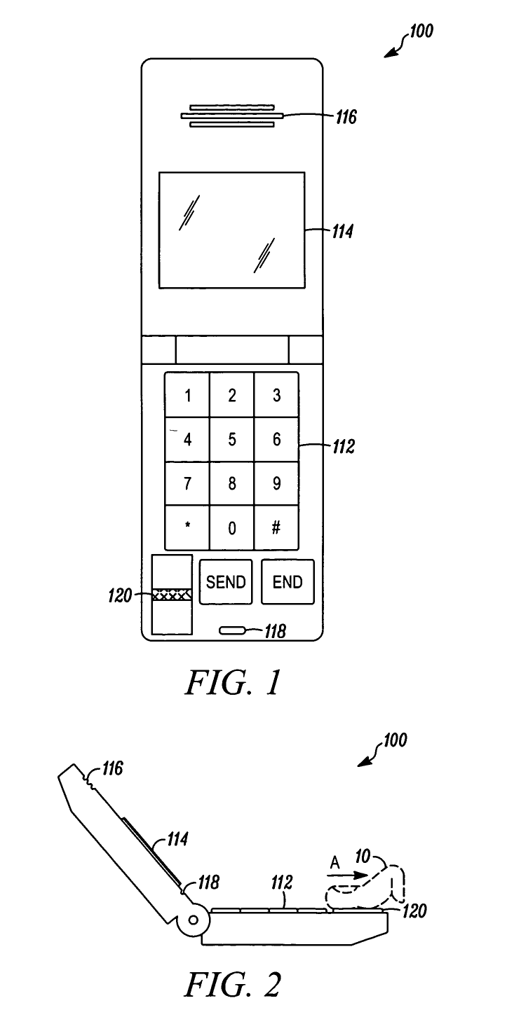

As shown in FIG. 1, one illustrative embodiment of the invention employs a wireless communications device, such as a cellular telephone 100, which includes a user input pad 112, a data output screen 114, an earpiece 116, a microphone 118 and a biometric input device, such as a fingerprint scanner 120. As shown in FIG. 2, the user may use the fingerprint scanner 120 by drawing a finger 10 across the fingerprint scanner 120 (such as in direction A) when requested to do so on the data output screen 114. While a wireless device is shown in FIGS. 1 and 2, it should be noted that the invention can be employed with any type of communication that employs encryption keys and it is intended that the scope of the claims below will apply to all such devices.

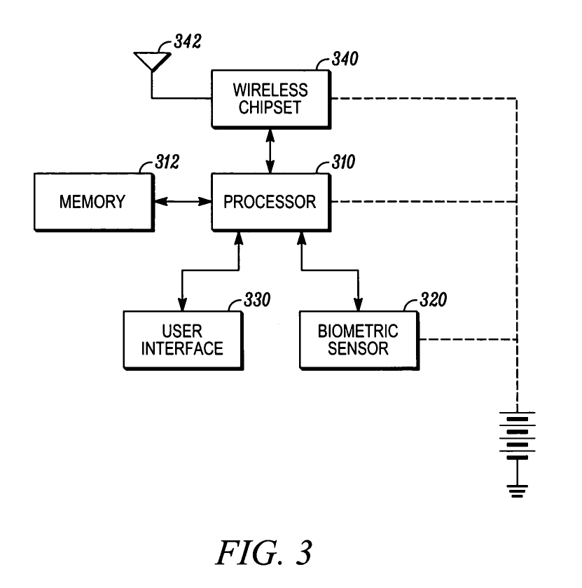

As shown in FIG. 3, the wireless communication device could include a processor 310 in data communication with a digital memory 312. The memory 312 may be used to store an encrypted key and a program used to control the processor 310. The processor receives input from a biometric sensor 320 and communicates with a user interface 330. (The user interface could, for example, include a keypad 112, a display 114, a microphone 118 and an earpiece 116b—as shown in FIGS. 1 and 2).) The processor 310 also communicates with a wireless transceiver including a wireless chipset 340, which transmits and receives communications via an antenna 342.

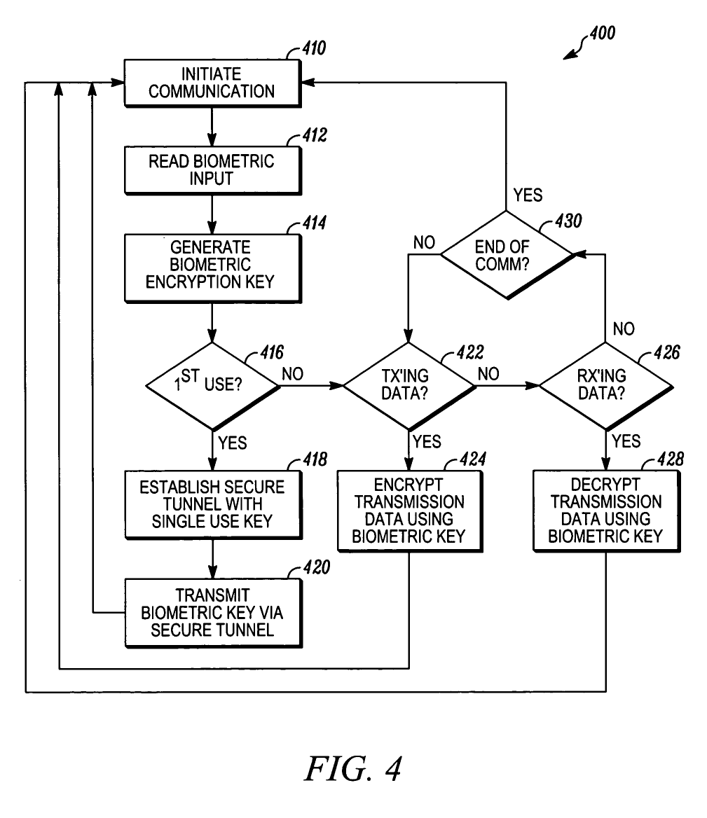

As shown in FIG. 4, when a user initiates a communication 410 between a local device and a remote device (such as a communications server), such as the disclosed apparatus, the device will initially read the biometric input 412 from the user using the biometric input interface, which generates a data representation of the biometric input. The device will then generate a biometric encryption key 414 by transforming the data representation of the biometric input using a set of rules, such as a known encryption key generating algorithm. The system can also use other types of data (e.g., a serial number of the device, etc.) in combination with the biometric input data to generate the biometric key, thereby generating a user-specific and device-specific biometric encryption key.

The system determines 416 if the encryption is being used for the first time. If so, the system will establish a secure tunnel with a single use key 418 (typically stored in the system or otherwise provided to the user). The system will then transmit the biometric key through the secure tunnel 420. The remote device will then provision an account for the local device, in which it requires use of the biometric encryption key for all subsequent encrypted communications between the local device and remote device.

The system might also store the biometric key in an internal digital memory and use the stored key for all subsequent communications. In this embodiment, the system is not required to generate the encryption key each time it enters into a new communication, thereby reducing the call-initiating overhead of the system.

It may be desirable not to store the biometric encryption key for security reasons. In such a situation, the device will regenerate the biometric encryption key each time it engages in a new communication.

If the system, at step 416, determines that the current communication is not a first use, then the system will determine if it is currently transmitting data 422 and, if so, it encrypts the transmission 424 (typically in the form of a plurality of data packets) using the biometric encryption key and transmits encrypted data packets to the remote device. If not, the system will determine if it is receiving data 426 and, if so, it decrypts the transmission 428 using the biometric encryption key. If not, then the system determines if the communication has ended 430 and, if so, it returns to step 410, otherwise it returns to step 422.

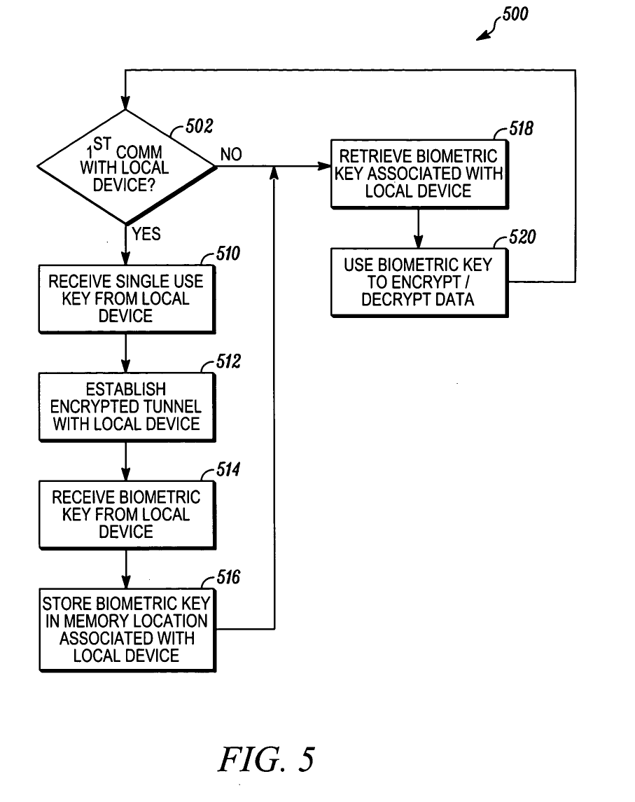

One way in which a communications server may interact with the local device is shown in FIG. 5. When a call is initiated by the local device, the server determines if the call is a first communication with the local device and, if so, it receives a single use only key 510 from the local device. The local device and the server establish an encrypted communication tunnel 512 employing the single use key. Then the server receives the biometric key 514 from the local device and stores it 516 in a memory location associated with the local device. If the result of test 502 indicates that the call is not a first communication, then the server retrieves the stored biometric key 518 and uses the biometric key 520 to encrypt and decrypt data subsequently communicated in the communication.

In one example of an embodiment employing fingerprint scanning technology, for first time users of a mobile device, the VPN tunnel will be established using existing Internet Key Exchange (IKE) techniques. When the tunnel is securely setup, the next step is to communicate a sequence of three messages between the SGW and the mobile device exchanging fingerprint (or other biometric) data for the mobile user, encrypted during the first time using only pre-shared, single use keys. The mobile device will request the user for a fingerprint scan on the device. The mobile device will then analyze this fingerprint scan and generate unique information based on the scan. The mobile device may request three, or more, scans to ensure a correct analysis. Once the analysis is completed, the information is conveyed over the tunnel to the secure gateway. The secure gateway will dynamically update the mobile user's record with this information. The mobile device software has the option of securely storing the finger print analysis or discarding it after the tunnel is torn down.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of facilitating an encrypted communication for use in communication between a local device, operated by a user, and a remote device, the method comprising the steps of:
receiving, from a biometric input interface, a data representation of a biometric feature of the user; and
transforming the data representation into a biometric encryption key using a predetermined set of rules.

2. The method of claim 1, further comprising the steps of:
transmitting a single-use key to the remote device, thereby establishing an encrypted communication tunnel; and
transmitting the biometric encryption key to the remote device via the encrypted communication tunnel, thereby enabling the remote device to provision an account for the local device so as to require use of the biometric encryption key for all subsequent encrypted communications between the local device and remote device.

3. The method of claim 1, further comprising the steps of:
encrypting at least one data packet using the biometric encryption key thereby creating an encrypted data packet; and
transmitting the encrypted data packet to the remote device.

4. The method of claim 1, further comprising the steps of:
receiving at least one data packet from the remote device; and
decrypting the data packet using the biometric encryption key thereby creating a decrypted data packet.

5. The method of claim 1, further comprising the step of receiving, from the biometric input interface, a data representation of the biometric feature of the user each time that a new encrypted communication is initiated.

6. The method of claim 1, further comprising the step of storing the encryption key in a digital memory.

7. The method of claim 6, further comprising the steps of:
encrypting at least one data packet using the biometric encryption key stored in the digital memory thereby creating an encrypted data packet; and
transmitting the encrypted data packet to the remote device.

8. The method of claim 6, further comprising the steps of:
receiving an encrypted data packet from the remote device; and
decrypting the encrypted data packet using the biometric encryption key stored in the digital memory thereby creating an decrypted data packet.

9. A method of provisioning an encrypted communication account for facilitating communications between a local device and a communications server, comprising the steps of:
receiving a single use only key from the local device at the communications server;
establishing an encrypted communication tunnel between the communications server and the local device employing the single use key;
receiving from the local device a biometric key via the encrypted communications tunnel; and
storing at the communications server the biometric key in a memory associated with the local device.

10. The method of claim 9, further comprising the step of using the biometric key to decrypt all subsequent encrypted communications from the local device to the communications server.

11. The method of claim 9, further comprising the step of using the biometric key to encrypt all communications to the local device from the communications server.

12. A device for communicating on a network, comprising:
a biometric input interface;
a processor, configured to transform a biometric data input from the biometric input interface into an encryption key and to encrypt data for transmission onto the network using the encryption key, thereby generating encrypted data; and
a transceiver configured to transmit the encrypted data to the network.

13. The device of claim 12, wherein the processor is further programmed to decrypt data received from the network employing the encryption key.

14. The device of claim 12, wherein the biometric input interface comprises a fingerprint scanner.

15. The device of claim 12, wherein the biometric input interface comprises a retinal scanner.

16. The device of claim 12, further comprising a digital memory that stores a single use key.

17. The device of claim 12, further comprising a digital memory that stores the encryption key for subsequent use.

18. The device of claim 12, wherein the transceiver comprises a wireless communications chip set.
